(19) United States
(12) Patent Application Publication
(10) Pub. No.: US 2025/0370836 A1
(43) Pub. Date: Dec. 4, 2025

(54) PROTECTING DATABASE AGAINST POTENTIALLY HARMFUL QUERIES

(71) Applicant: Rubrik, Inc., Palo Alto, CA (US)

(72) Inventors: Travis Morrissey, Pleasanton, CA (US); Gabriel Lam, Seattle, WA (US); Rajorshi Sen, Redmond, WA (US); Manjunath Chinni, Saratoga, CA (US); Rahul Das, Bangalore (IN); Abhishek Kumar, San Jose, CA (US); Hardik Vohra, Sunnyvale, CA (US); Veera Venkata Naga Rama Satyam Kandula, San Jose, CA (US); Yashwanth Kumar Betha, Bangalore (IN)

(21) Appl. No.: 18/677,591

(22) Filed: May 29, 2024

(51) Int. Cl. G06F 11/07

(52) U.S. Cl. CPC G06F 11/0757; G06F 11/0709; G06F 11/0793; G06F 2201/80; G06F 2201/83

(57) ABSTRACT

Methods, systems, and devices for data management are described. A query execution module may obtain a first query to interact with a database, and then may compare a first fingerprint associated with the first query (e.g., a unique identifier of the first query) with a set of fingerprints in a fingerprint database. The set of fingerprints in the fingerprint database may correspond to one or more respective queries that are associated with an execution restriction by the database. In some aspects, the execution restriction may be based on execution details of the respective queries, including a length of time taken to execute a query, a quantity of failed executions of the query, among other details. The query execution module may then control an execution of the first query based on whether the first fingerprint has a corresponding matching fingerprint to at least one of the fingerprints in the fingerprint database.

### FIELD OF TECHNOLOGY

The present disclosure relates generally to data management, including techniques for protecting database against potentially harmful queries.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports protecting database against potentially harmful queries in accordance with aspects of the present disclosure.

FIG. 2 shows an example of a query execution flow that supports protecting database against potentially harmful queries in accordance with aspects of the present disclosure.

FIG. 3 shows an example of a process flow that supports protecting database against potentially harmful queries in accordance with aspects of the present disclosure.

FIG. 4 shows a block diagram of an apparatus that supports protecting database against potentially harmful queries in accordance with aspects of the present disclosure.

FIG. 5 shows a block diagram of a database manager that supports protecting database against potentially harmful queries in accordance with aspects of the present disclosure.

FIG. 6 shows a diagram of a system including a device that supports protecting database against potentially harmful queries in accordance with aspects of the present disclosure.

FIGS. 7 through 9 show flowcharts illustrating methods that support protecting database against potentially harmful queries in accordance with aspects of the present disclosure.

### DETAILED DESCRIPTION

Network operators may execute queries (e.g., structured query language (SQL) queries) in order to request and obtain information from a database management system (DMS), which maintains data within a database. For example, a network operator may execute one or more queries in order to retrieve data from the database or to modify the data within a database (e.g., adding or removing data from the database). Some systems may execute queries across multiple clients during normal operation, where up to thousands of queries (or more) may be executed per second. In some cases, however, as the quantity of clients with access to the database increases, a corresponding rise in the quantity of executed queries and in the demand for query execution at the database may also occur. The increase in clients also increases the risk for a rogue client which may dominate the database resources or may otherwise consume a majority of the database resources to execute queries. For example, For example, the rogue client may consume a majority of the database resources by executing a computationally expensive query, which may negatively impact other clients with data present at the database or in some aspects act as a denial of service attack for other clients attempting to access the database. Additionally or alternatively, the database may be subject to different sub-optimal queries that take a long time to execute (relative to other queries) or that consume excessive database resources, which may degrade the performance of the database and reduce the overall efficiency of database services.

In order to protect the database against potentially harmful queries and rogue clients, a DMS may implement a query execution module that automatically monitors and manages the execution of queries. For example, any new query to the database may be evaluated by the query execution module, which identifies a fingerprint that is specific to the incoming query. The query execution module then checks for a corresponding match to fingerprint of the incoming query to a set of fingerprints associated with previously evaluated queries in a fingerprint database. For example, the fingerprint database may include different unique fingerprints of previously blocked queries along with details relating to the blocked queries, such as a number of times a query was executed, the time taken for the query to execute, a number of times the query errored out or failed, when or if the query was previously blocked or identified as problematic, among other possible informative details of the query. For example, if the query execution module identifies that a certain query has a match to a query in the fingerprint database that was previously identified as a harmful query, the query execution module can automatically block the query from running again.

Aspects of the disclosure may be implemented to realize one or more potential advantages. For example, the automatic identification and blocking of harmful or expensive queries may reduce the downtime of the database and increase the efficiency of database services. For example, the database may spend less time attempting to execute a potentially harmful query, and more time executing normal queries. Additionally or alternatively, the identification and blocking of potentially harmful queries may allow for the DMS to handle a potentially rogue client and maintain a reasonable distribution of database resources among different clients. For example, the query execution module may block or kill queries identified as being from a rogue client in order to control effectively manage database resources across different clients. Additionally or alternatively, the identification and blocking of potentially harmful queries may reduce the database load, especially for times in which the database is under duress due to high demand or database traffic.

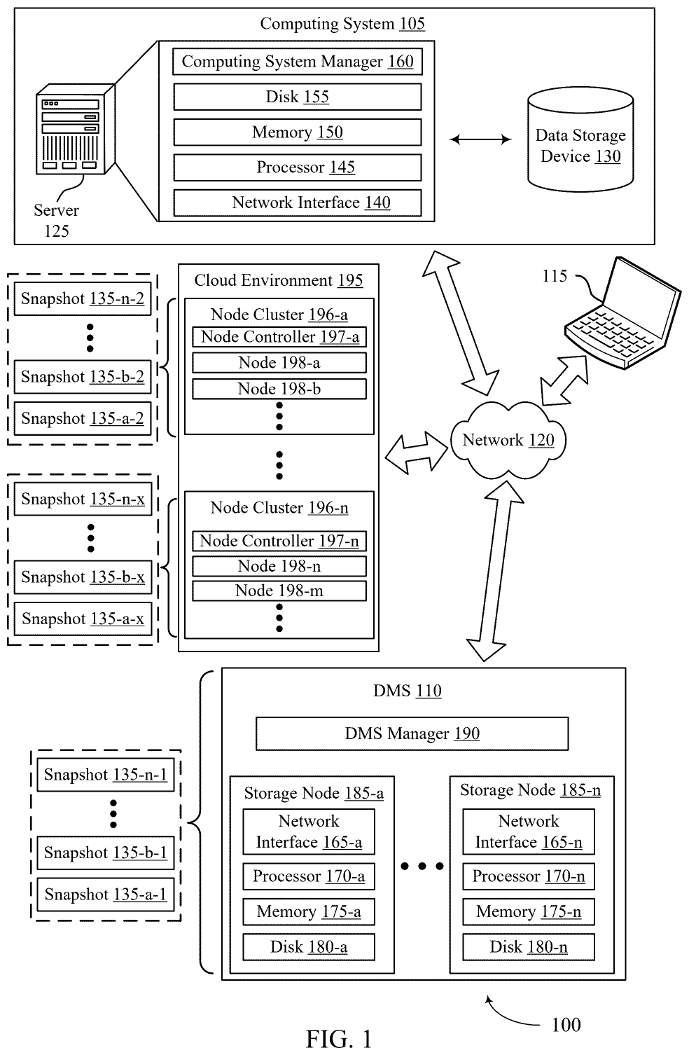

FIG. 1 illustrates an example of a computing environment 100 that supports protecting database against potentially harmful queries in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185 (e.g., storage node 185-a through storage node 185-n). The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 (e.g., network interface 165-a through network interface 165-n) may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 (e.g., processor 170-a through processor 170-n) may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 (e.g., disk 180-a through disk 180-n) may include one or more HDDs, one or more SDDs, or any combination thereof. Memories 175 (e.g., memory 175-a through memory 175-n) and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state-which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally or alternatively, the DMS 110 may detect whether aspects of the computing system 105 have been impacted by malware (e.g., ransomware). Additionally or alternatively, the DMS 110 may relocate data or create copies of data based on using one or more snapshots 135 to restore the associated computing object within its original location or at a new location (e.g., a new location within a different computing system 105). Additionally or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 (e.g., node 198-a, node 198-b, node 198-m, node 198-n) of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 (e.g., node controller 197-a through node controller 197-n) for the various node clusters via the network 120. For example, the control plane may exchange communications for backup and recovery tasks with the node controllers 197 in the form of transmission control protocol (TCP) packets via the network 120.

The DMS 110 may obtain different queries (e.g., SQL queries) from different network operators or clients to retrieve data from the database or to make changes to the data within a database (e.g., adding, removing, or modifying data from the database). In some implementations, the DMS 110 may execute up to thousands of queries (or more) per second across multiple different clients. In some cases, however, as the quantity of clients with access to the database increases, a corresponding rise in the quantity of executed queries at the database may also occur. The increase in the quantity of served clients may also increase the risk for a rogue client that dominates network or database resources. Additionally or alternatively, the database may be subject to different kinds of sub-optimal queries, which may degrade the performance of the database and reduces the overall efficiency of database services.

In order to protect the database against potentially harmful queries or rogue clients, a DMS 110 may support a query execution module that monitors and manages the execution of queries. For example, any new query to the database may be evaluated by the query execution module, which identifies a fingerprint that is specific to the incoming query. The query execution module then checks for a corresponding match to the fingerprint of the incoming query to a set of previously evaluated queries in a fingerprint database. For example, the fingerprint database may include different unique fingerprints of previously blocked queries along with details relating to the blocked queries, such as a number of times a query was executed, the time taken for the query to execute, a number of times the query errored out or failed, when or if the query was previously blocked or identified as problematic, among other possible informative details of the query. For example, if the query execution module identifies that a certain query has a match to a query in the fingerprint database that was previously identified as a harmful query, the query execution module can automatically block the query from running again in order to avoid running the potentially harmful query.

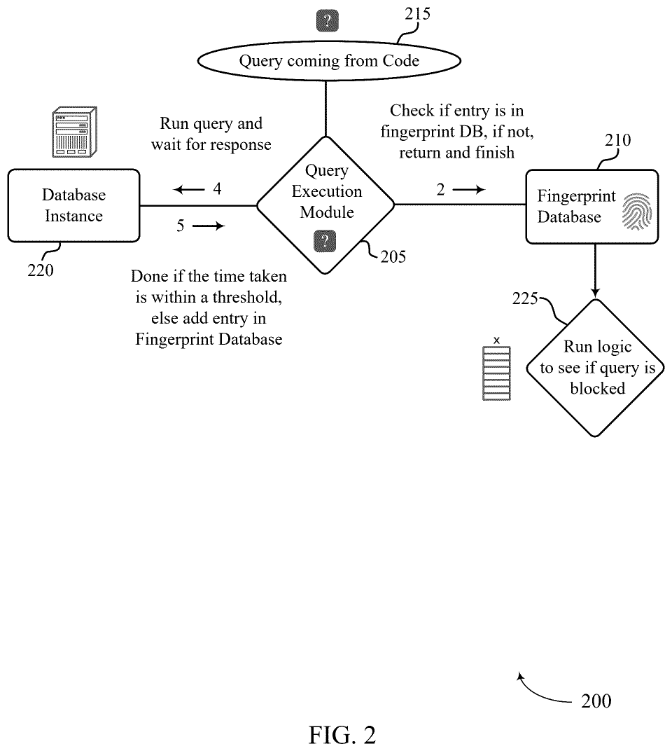

FIG. 2 shows an example of a query execution flow 200 that supports protecting database against potentially harmful queries in accordance with aspects of the present disclosure. For example, the query execution flow 200 illustrates a process for obtaining one or more queries at a query execution module 205 which controls the execution of the one or more queries (e.g., by allowing the one or more queries to run or by blocking or killing the one or more queries) by comparing corresponding fingerprints associated with the one or more queries to a set of fingerprints (that correspond to previously blocked queries) stored in a fingerprint database.

A database may include a structured collection of data that is managed by a DMS such as MySQL server, among other DMS types. In some implementations, a SQL database such as a MySQL database may store metadata that helps provide clients or other database users with access to data along with different backup, recovery, and security features for data. Some such databases may be relational databases that store data in separate tables, and the database structures may be organized into physical files that allow for efficient access to data. Such relational databases may be organized by relationships between different data fields, such as one-to-one, one-to-many, unique, required or optional, and “pointers” between different tables.

Some different workflows may include interacting with the database, and different clients or database operators may write different queries (e.g., SQL queries) in order to interact with or otherwise access the database. For example, a database operator may run different queries to the database in order to obtain, add, or otherwise modify data in the database. In some implementations, a database may execute a relatively large quantity of queries in a duration of time, for example, up to thousands of queries per second or more during times of high traffic or high demand at the database. In addition, a database may host data and provide services for multiple different clients that may increase over time. Thus, inefficiencies for query execution at the database may cause challenges.

In some examples, a database structure may support rate limiting features at a service level of the database, which may limit the quantity of open connections that a service can make to the database service (e.g., the rate limiting features may stop a service from opening infinite number of connections or at least up to a threshold number of connections). Such rate limiting features provide an efficient solution for limiting the number of open connections when the total quantity of services remains below a threshold, since the total number of connections allowed for the services is less than a maximum number of connections the database service can handle. As the number of micro-services increases, however, the total number of allowed connections to the database rises to a level that is greater than the number of connections that the database service can handle. Such excess connections to the database may introduce performance issues for the database service as the quantity of queries to the database increases.

Additionally or alternatively, the database service may encounter harmful queries (e.g., queries that dominate database resources, take an extensive amount of time to run, queries from a rogue client, among other sub-optimal queries) that may cause query pileup (e.g., backlog) and performance degradation at the database. For example, if a query runs for more than a threshold amount of time or ends up in a perpetual execution state (e.g., the query fails to make execution progress for a threshold amount of time), the database instance 220 may restart, causing downtime of the database for up to ten minutes or more. In some other cases, data recovery of the database may become challenging when the database faces a high workload or a large number of queries.

In some implementations, a database operator may implement manual reductions to the database workload by killing or blocking queries that have been previously identified as being problematic. Some such manual fixes, however, may be relatively inefficient and may require consistent monitoring of the database. In order to protect the database against potentially harmful queries or rogue clients, a DMS may support a query execution module 205 which may automatically (e.g., without external or human intervention) monitor and manage the execution of queries to the database instance 220 (e.g., a cloud SQL database). For example, at step 1, an incoming query 215 to the database instance 220 may (coming from the code which runs the query) be evaluated by the query execution module 205, which identifies a fingerprint or an identifier that is specific to the incoming query 215. The query execution module 205 then checks for a corresponding match to the fingerprint of the incoming query 215 to a set of fingerprints associated with previously evaluated queries in the fingerprint database 210. For example, the fingerprint database 210 may include different unique fingerprints of previously blocked queries (or queries that have been previously flagged as being problematic or harmful), including details relating to the blocked queries, such as a number of times a query was executed, the time taken for a query to execute (e.g. a maximum execution time, a median execution time, an average execution time), a number of times the query errored out or failed, when or if the query was previously blocked or identified as problematic via external intervention, whether the query has been blocked internally, a timeout associated with the query, among other possible informative details or metadata related to the previously blocked queries.

At step 2, the query execution module 205 may run logic 225 to check if the fingerprint of the incoming query 215 has a match to a fingerprint associated with a previously blocked query. In some examples, if the logic 225 determines that the fingerprint associated with the incoming query 215 has a match to one or more fingerprints associated with previously blocked queries in the fingerprint database 210, the query may be blocked or killed in order to avoid running the incoming query 215, which may be a potentially harmful query. In some aspects, the query execution module 205 may check the query details associated with the matching fingerprint in the fingerprint database. If the matching fingerprint is associated with a previously blocked query (e.g., if the query is blocked by external intervention), for example, the query execution module 205 may return an error or automatically kill the query.

In some other examples, if the logic 225 may identify that there is no match to the fingerprint of the incoming query in the fingerprint database 210. In cases where the logic 225 determines that there is no match, then the incoming query 215 may be returned to the query execution module 205 for execution at step 3. Additionally or alternatively, if the incoming query 215 has a “do not block” hint, the query execution module 205 may override any possible fingerprint match and may run the query regardless of whether the query was previously blocked. At step 4, the query execution module 205 may run the query and wait for a response from the database instance 220. If the query execution at the database instance 220 remains within a threshold execution time at step 5, the query is returned to the query execution module 205. If the query execution at the database instance 220 exceeds a threshold execution time at step 5, then the query execution module 205 may add the fingerprint associated with the incoming query 215 to the fingerprint database 210 along with a timeout, or a time duration for which the fingerprint associated with the incoming query 215 may remain in the fingerprint database. For example, one the timeout expires, the fingerprint associated with the incoming query 215 may be released from the fingerprint database 210. In some aspects, if a query having the same fingerprint is executed and added to the fingerprint database after addition of the fingerprint associated with the incoming query 215, the timeout may re-set (and may re-set every time a same fingerprint is added or re-added to the fingerprint database 210). In some implementations, the query may be blocked after being added to the fingerprint database 210 a certain number of times (if the query is not already blocked by external intervention). For example, if the fingerprint of a query is added for a first time to the fingerprint database 210, then the query may not be immediately blocked, but after a certain amount of additions of the same query to the fingerprint database 210, the query may be blocked.

Monitoring and managing incoming queries using the query execution module 205 may protect the database from potentially harmful (and repetitively harmful) queries. In some aspects, the query execution module 205 may ensure that any rogue service can be rate limited at the query level, and that repetitively harmful queries from a rogue service can be blocked (or can at least be blocked for a timeout before being unblocked). The query execution module 205 may allow for more efficient identification and management of queries from rogue clients so that the potentially harmful queries can be identified and blocked before risking bringing the database down.

Additionally or alternatively, the query execution module 205 may be able to identify potentially harmful queries based on statistical similarities between a new query and previously blocked or flagged queries. For example, if a new query does not have a matching fingerprint in the fingerprint database 210 but is similar to a previously blocked query (e.g., based on statistics related to the new query or the structure of the new query), the query execution module 205 may kill the query to prevent execution of a potentially harmful query to the database instance 220. In some other examples, the query execution module 205 may determine whether to block or kill similar queries based on a current load of the database. For example, if the database has a load that currently exceeds a threshold, then the query execution module 205 may determine to block or kill new queries that are statistically similar enough to previously blocked queries (e.g., similar enough such that the new queries share at least a threshold quantity of characteristics with previously blocked queries).

In some other implementations, the query execution module 205 may support a configuration that can be used to kill or block queries whenever the database is under duress. For example, the query execution module 205 may monitor one or more metrics associated with database duress, and may begin killing or blocking queries when the database is under duress. For example, the query execution module 205 may automatically kill non-essential queries (e.g., queries associated with Korg jobs, which may run containerized applications and evaluate traffic between applications across a working cluster of the database and outside the cluster) in order to reduce the database load. Additionally or alternatively, the query execution module 205 may automatically block or kill queries that are expensive to the database (e.g., queries that take over a threshold amount of time to run or queries that consume over a threshold amount of resources) when the database is under duress.

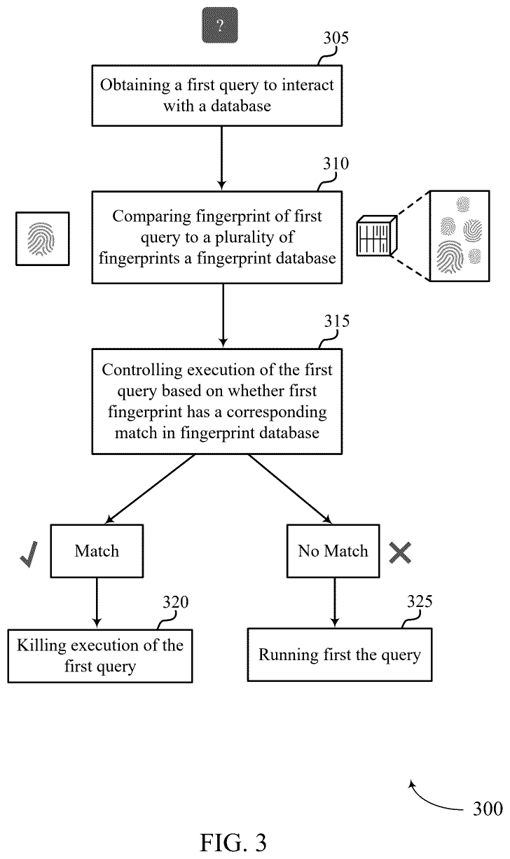

FIG. 3 shows an example of a process flow 300 that supports protecting database against potentially harmful queries in accordance with aspects of the present disclosure. For example, the process flow 300 illustrates a process for obtaining one or more queries at a query execution module which controls the execution of the one or more queries (e.g., by allowing the one or more queries to run or by blocking or killing the one or more queries) by comparing corresponding fingerprints associated with the one or more queries to a set of fingerprints (that correspond to previously blocked queries) stored in a fingerprint database.

Alternative examples of the following may be implemented. Some steps are performed in a different order than described or are not performed at all. In some implementations, steps may include additional features not mentioned below, or additional steps may be added. Further, although interactions between a query execution module and other internal or external database components are shown performing the operations of the process flow 300, some aspects of some operations may also be performed by other modules or components not shown.

At 305, the query execution module may obtain a first query to interact with a database. In some examples, the first query is a SQL query within code, and the code sends the first query to the query execution module.

At 310, the query execution module may compare a first fingerprint associated with the first query to a set of fingerprints stored in a fingerprint database. In some aspects, the set of fingerprints that are stored in the fingerprint database correspond to one or more respective queries that are associated with an execution restriction by the database. For example, the one or more respective queries may be queries (and associated fingerprints) that have been previously blocked for execution by the database for at least a threshold duration of time. In some other examples, the execution restriction associated with the one or more respective queries may be based on a set of execution details (e.g., time taken for execution, quantity of failed executions, among other details) stored with respective fingerprints of the set of fingerprints. In some cases, the fingerprint database may store corresponding metadata associated with the set of fingerprints (e.g., a quantity of attempted executions for a respective query, time data for a duration of time taken to execute the respective query, a quantity of returned errors for the respective query, one or more indications of whether the respective query is internally blocked, externally blocked, or both, a quantity of timeouts associated with the respective query, or any combination thereof).

At 315, the query execution module may control an execution of the first query based on whether the first fingerprint has a corresponding matching fingerprint to at least one fingerprint of the set of fingerprints stored in the fingerprint database. In some examples, controlling the execution of the first query may include killing the query at 320 based on the first fingerprint having a corresponding match to at least one fingerprint stored in the fingerprint database, where the corresponding matching fingerprint is indicative of a blocked query. In some other examples, controlling the execution of the first query may include running the query at 325 based on the first fingerprint lacking at least one matching fingerprint stored in the fingerprint database.

In some implementations, the query execution module may run the first query for a duration of time. If the duration of time is equal to or exceeds a threshold run time, the query execution module may add the first fingerprint to the set of fingerprints stored in the fingerprint database. In some examples, the first fingerprint may be released from the fingerprint database based on an expiration of a timeout duration assigned to the first fingerprint upon being added to the fingerprint database. In some cases, the timeout duration may be reset for the first fingerprint if one or more second instance of the run time of the first query exceeds the threshold run time.

In some cases, the query execution module may obtain the first query along with a hint that overrides any potential block of the first query. For example, the query execution module may run the first query irrespective of whether the first fingerprint has a corresponding matching corresponding fingerprint in the fingerprint database. In some other cases, the query execution module may run the query based on the query lacking a threshold quantity of statistical similarities to one or more second queries that have corresponding matching fingerprints to at least one of the set of fingerprints stored in the fingerprint database (e.g., if the first fingerprint is statistically dissimilar to the set of fingerprints stored in the fingerprint database, then the query execution module may run the query). Alternatively, if the query has a threshold quantity of statistical similarities to the one or more second queries that have corresponding matching fingerprints to at least one of the set of fingerprints stored in the fingerprint database, the query execution module may kill the query (e.g., if the first fingerprint is statistically similar to the set of fingerprints stored in the fingerprint database, then the query execution module may kill the query).

In some implementations, the query execution module may kill the execution of the first query based on a database load exceeding a load threshold. For example, if the database is subject to a high load (e.g., an increased quantity of queries, increased rate of queries, among other load metrics) at a point in time or for a duration of time, the query execution module may kill one or more queries to reduce the high load at the database for a duration of time. Additionally or alternatively, the query execution module kill the execution of the first query (and one or more subsequent queries) based on one or more characteristics of duress being present for the database associated with the first query.

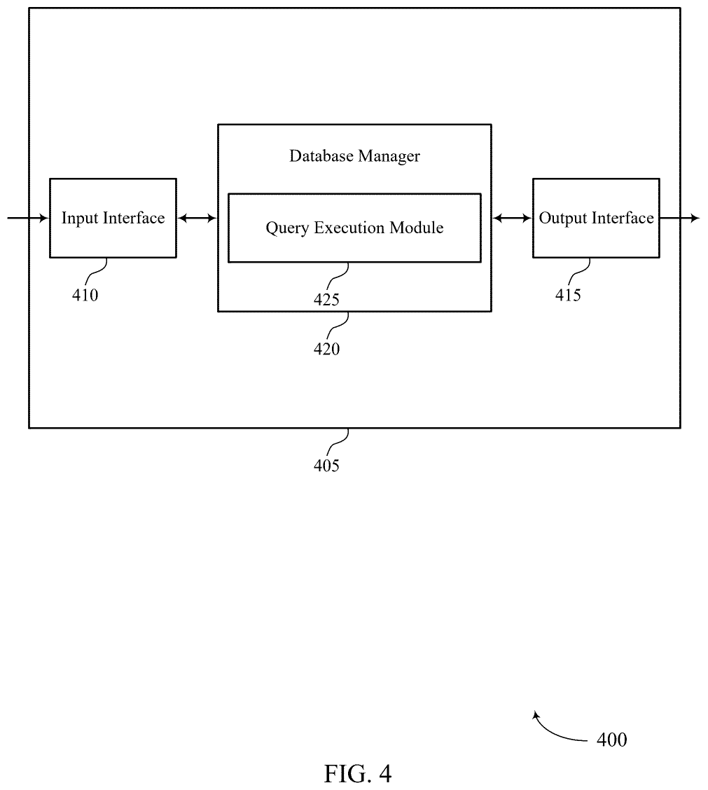

FIG. 4 shows a block diagram 400 of a system 405 that supports protecting database against potentially harmful queries in accordance with aspects of the present disclosure. In some examples, the system 405 may be an example of aspects of one or more components described with reference to FIG. 1, such as a DMS 110. The system 405 may include an input interface 410, an output interface 415, and a database manager 420. The system 405 may also include one or more processors. Each of these components may be in communication with one another (e.g., via one or more buses, communications links, communications interfaces, or any combination thereof).

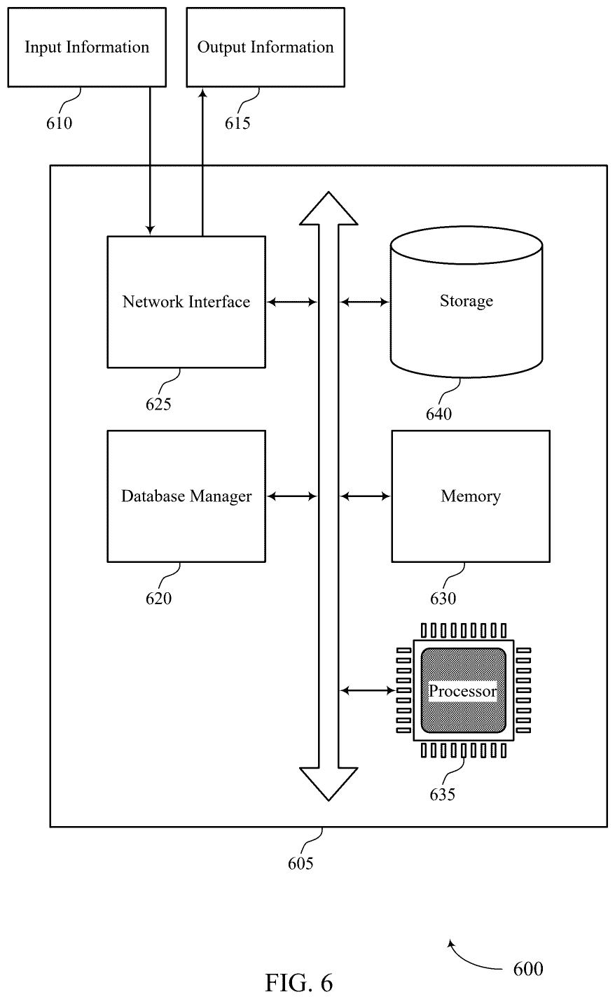

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the database manager 420 to support protecting database against potentially harmful queries. In some cases, the input interface 410 may be a component of a network interface 625 as described with reference to FIG. 6.

The output interface 415 may manage output signaling for the system 405. For example, the output interface 415 may receive signaling from other components of the system 405, such as the database manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the database manager 420 may include a query execution module 425, or any combination thereof. In some examples, the database manager 420, or various components thereof, may be configured to perform various operations (e.g., receiving, monitoring, transmitting) using or otherwise in cooperation with the input interface 410, the output interface 415, or both. For example, the database manager 420 may receive information from the input interface 410, send information to the output interface 415, or be integrated in combination with the input interface 410, the output interface 415, or both to receive information, transmit information, or perform various other operations as described herein.

The query execution module 425 may be configured as or otherwise support a means for obtaining, at a query execution module, a first query to interact with a database. The query execution module 425 may be configured as or otherwise support a means for comparing, by the query execution module, a first fingerprint associated with the first query to a set of multiple fingerprints stored in a fingerprint database, where the set of multiple fingerprints stored in the fingerprint database correspond to one or more respective queries that are associated with an execution restriction by the database based on a set of execution details stored with respective fingerprints of the set of multiple fingerprints. The query execution module 425 may be configured as or otherwise support a means for controlling an execution of the first query based on whether the first fingerprint has a corresponding matching fingerprint to at least one of the set of multiple fingerprints stored in the fingerprint database.

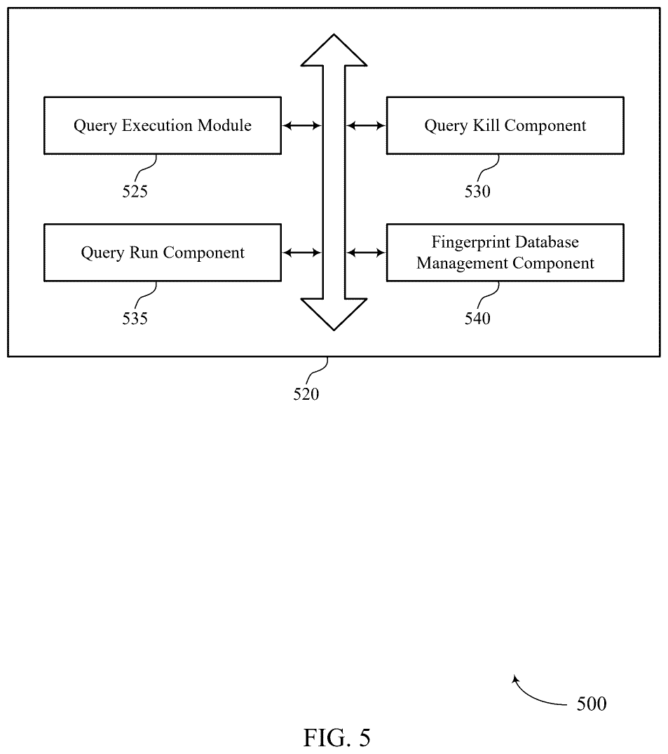

FIG. 5 shows a block diagram 500 of a database manager 520 that supports protecting database against potentially harmful queries in accordance with aspects of the present disclosure. The database manager 520 may be an example of aspects of a database manager or a database manager 420, or both, as described herein. The database manager 520, or various components thereof, may be an example of means for performing various aspects of protecting database against potentially harmful queries as described herein. For example, the database manager 520 may include a query execution module 525, a query kill component 530, a query run component 535, a fingerprint database management component 540, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The query execution module 525 may be configured as or otherwise support a means for obtaining, at a query execution module, a first query to interact with a database. In some examples, the query execution module 525 may be configured as or otherwise support a means for comparing, by the query execution module, a first fingerprint associated with the first query to a set of multiple fingerprints stored in a fingerprint database, where the set of multiple fingerprints stored in the fingerprint database correspond to one or more respective queries that are associated with an execution restriction by the database based on a set of execution details stored with respective fingerprints of the set of multiple fingerprints. In some examples, the query execution module 525 may be configured as or otherwise support a means for controlling an execution of the first query based on whether the first fingerprint has a corresponding matching fingerprint to at least one of the set of multiple fingerprints stored in the fingerprint database.

In some examples, to support controlling the execution of the first query, the query kill component 530 may be configured as or otherwise support a means for killing the execution of the first query based on the first fingerprint having a matching fingerprint to at least one of the set of multiple fingerprints stored in the fingerprint database, where the corresponding matching fingerprint is indicative of a blocked query.

In some examples, to support controlling the execution of the first query, the query run component 535 may be configured as or otherwise support a means for running the first query based on the first fingerprint lacking a matching fingerprint to at least one of the set of multiple fingerprints stored in the fingerprint database.

In some examples, the fingerprint database management component 540 may be configured as or otherwise support a means for adding the first fingerprint to the set of multiple fingerprints stored in the fingerprint database based on a first instance of a run time of the first query exceeding a threshold run time. In some examples, the fingerprint database management component 540 may be configured as or otherwise support a means for releasing the first fingerprint from the set of multiple fingerprints stored in the fingerprint database based on an expiration of a timeout duration associated with the first fingerprint.

In some examples, the fingerprint database management component 540 may be configured as or otherwise support a means for adding the first fingerprint to the set of multiple fingerprints stored in the fingerprint database based on one or more second instances of the run time of the first query exceeding the threshold run time. In some examples, the fingerprint database management component 540 may be configured as or otherwise support a means for resetting the timeout duration for the first fingerprint based on one or more second instances of the run time of the first query exceeding the threshold run time.

In some examples, to support controlling the execution of the first query, the query run component 535 may be configured as or otherwise support a means for running the first query based on the first query being associated with a hint that overrides a block of the first query.

In some examples, to support controlling the execution of the first query, the query run component 535 may be configured as or otherwise support a means for running the first query based on the first query lacking a threshold quantity of statistical similarities to one or more second queries that have corresponding matching fingerprints to at least one of the set of multiple fingerprints stored in the fingerprint database.

In some examples, to support controlling the execution of the first query, the query kill component 530 may be configured as or otherwise support a means for killing the execution of the first query based on the first query having a threshold quantity of statistical similarities to one or more second queries that have corresponding matching fingerprints to at least one of the set of multiple fingerprints stored in the fingerprint database.

In some examples, to support killing the execution of the first query, the query kill component 530 may be configured as or otherwise support a means for killing the execution of the first query based on a database load associated with query execution of the database exceeding a load threshold. In some examples, the fingerprint database stores the set of multiple fingerprints and corresponding metadata associated with the set of multiple fingerprints.

In some examples, the corresponding metadata associated with the set of multiple fingerprints includes a quantity of attempted executions for a respective query, time data for a duration of time taken to execute the respective query, a quantity of returned errors for the respective query, one or more indications of whether the respective query is internally blocked, externally blocked, or both, a quantity of timeouts associated with the respective query, or any combination thereof.

In some examples, to support killing the execution of the first query, the query kill component 530 may be configured as or otherwise support a means for killing the execution of the first query and one or more subsequent queries based on one or more characteristics of duress being present for the database associated with the first query. In some examples, the first query includes a structured query language (SQL) query within code that sends the first query to the query execution module.

FIG. 6 shows a block diagram 600 of a system 605 that supports protecting database against potentially harmful queries in accordance with aspects of the present disclosure. The system 605 may be an example of or include components of a system 405 as described herein. The system 605 may include components for data management, including components such as a database manager 620, an input information 610, an output information 615, a network interface 625, at least one memory 630, at least one processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting protecting database against potentially harmful queries). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

For example, the database manager 620 may be configured as or otherwise support a means for obtaining, at a query execution module, a first query to interact with a database. The database manager 620 may be configured as or otherwise support a means for comparing, by the query execution module, a first fingerprint associated with the first query to a set of multiple fingerprints stored in a fingerprint database, where the set of multiple fingerprints stored in the fingerprint database correspond to one or more respective queries that are associated with an execution restriction by the database based on a set of execution details stored with respective fingerprints of the set of multiple fingerprints. The database manager 620 may be configured as or otherwise support a means for controlling an execution of the first query based on whether the first fingerprint has a corresponding matching fingerprint to at least one of the set of multiple fingerprints stored in the fingerprint database.

By including or configuring the database manager 620 in accordance with examples as described herein, the system 605 may support techniques for protecting database against potentially harmful queries, which may provide one or more benefits such as, for example, reduced query execution latency, improved user experience, more efficient utilization of computing resources, network or database resources or both, improved scalability, improved security, improved control over query execution across multiple different clients with access to a database, improved techniques for handling database workload, improved efficiency for query execution, reduced resource expenditure, among other possibilities.

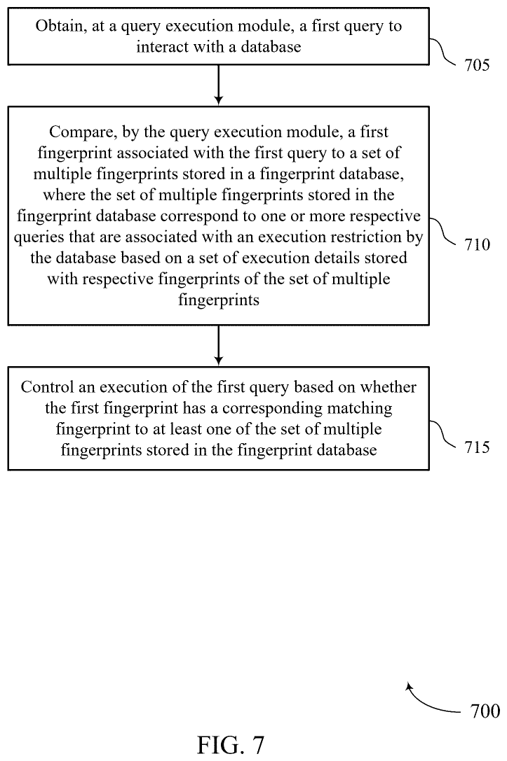

FIG. 7 shows a flowchart illustrating a method 700 that supports protecting database against potentially harmful queries in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include obtaining, at a query execution module, a first query to interact with a database. The operations of 705 may be performed in accordance with examples as disclosed herein. In some examples, aspects of the operations of 705 may be performed by a query execution module 525 as described with reference to FIG. 5.

At 710, the method may include comparing, by the query execution module, a first fingerprint associated with the first query to a set of multiple fingerprints stored in a fingerprint database, where the set of multiple fingerprints stored in the fingerprint database correspond to one or more respective queries that are associated with an execution restriction by the database based on a set of execution details stored with respective fingerprints of the set of multiple fingerprints. The operations of 710 may be performed in accordance with examples as disclosed herein. In some examples, aspects of the operations of 710 may be performed by a query execution module 525 as described with reference to FIG. 5.

At 715, the method may include controlling an execution of the first query based on whether the first fingerprint has a corresponding matching fingerprint to at least one of the set of multiple fingerprints stored in the fingerprint database. The operations of 715 may be performed in accordance with examples as disclosed herein. In some examples, aspects of the operations of 715 may be performed by a query execution module 525 as described with reference to FIG. 5.

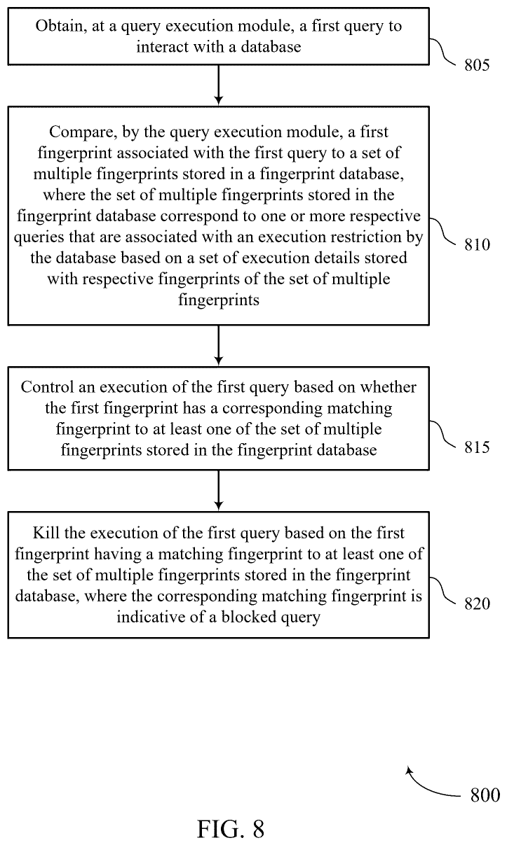

FIG. 8 shows a flowchart illustrating a method 800 that supports protecting database against potentially harmful queries in accordance with aspects of the present disclosure. The operations of the method 800 may be implemented by a DMS or its components as described herein. For example, the operations of the method 800 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 805, the method may include obtaining, at a query execution module, a first query to interact with a database. The operations of 805 may be performed in accordance with examples as disclosed herein. In some examples, aspects of the operations of 805 may be performed by a query execution module 525 as described with reference to FIG. 5.

At 810, the method may include comparing, by the query execution module, a first fingerprint associated with the first query to a set of multiple fingerprints stored in a fingerprint database, where the set of multiple fingerprints stored in the fingerprint database correspond to one or more respective queries that are associated with an execution restriction by the database based on a set of execution details stored with respective fingerprints of the set of multiple fingerprints. The operations of 810 may be performed in accordance with examples as disclosed herein. In some examples, aspects of the operations of 810 may be performed by a query execution module 525 as described with reference to FIG. 5.

At 815, the method may include controlling an execution of the first query based on whether the first fingerprint has a corresponding matching fingerprint to at least one of the set of multiple fingerprints stored in the fingerprint database. The operations of 815 may be performed in accordance with examples as disclosed herein. In some examples, aspects of the operations of 815 may be performed by a query execution module 525 as described with reference to FIG. 5.

At 820, the method may include killing the execution of the first query based on the first fingerprint having a matching fingerprint to at least one of the set of multiple fingerprints stored in the fingerprint database, where the corresponding matching fingerprint is indicative of a blocked query. The operations of 820 may be performed in accordance with examples as disclosed herein. In some examples, aspects of the operations of 820 may be performed by a query kill component 530 as described with reference to FIG. 5.

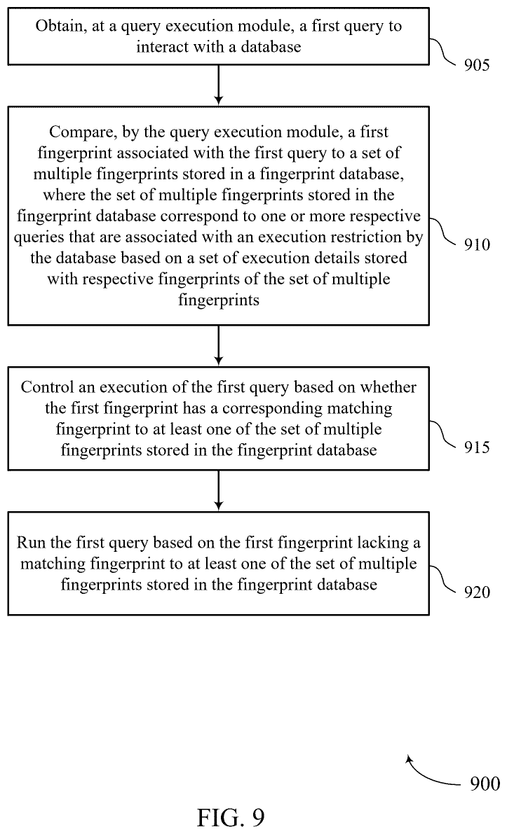

FIG. 9 shows a flowchart illustrating a method 900 that supports protecting database against potentially harmful queries in accordance with aspects of the present disclosure. The operations of the method 900 may be implemented by a DMS or its components as described herein. For example, the operations of the method 900 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 905, the method may include obtaining, at a query execution module, a first query to interact with a database. The operations of 905 may be performed in accordance with examples as disclosed herein. In some examples, aspects of the operations of 905 may be performed by a query execution module 525 as described with reference to FIG. 5.

At 910, the method may include comparing, by the query execution module, a first fingerprint associated with the first query to a set of multiple fingerprints stored in a fingerprint database, where the set of multiple fingerprints stored in the fingerprint database correspond to one or more respective queries that are associated with an execution restriction by the database based on a set of execution details stored with respective fingerprints of the set of multiple fingerprints. The operations of 910 may be performed in accordance with examples as disclosed herein. In some examples, aspects of the operations of 910 may be performed by a query execution module 525 as described with reference to FIG. 5.

At 915, the method may include controlling an execution of the first query based on whether the first fingerprint has a corresponding matching fingerprint to at least one of the set of multiple fingerprints stored in the fingerprint database. The operations of 915 may be performed in accordance with examples as disclosed herein. In some examples, aspects of the operations of 915 may be performed by a query execution module 525 as described with reference to FIG. 5.

At 920, the method may include running the first query based on the first fingerprint lacking a matching fingerprint to at least one of the set of multiple fingerprints stored in the fingerprint database. The operations of 920 may be performed in accordance with examples as disclosed herein. In some examples, aspects of the operations of 920 may be performed by a query run component 535 as described with reference to FIG. 5.

A method by an apparatus is described. The method may include obtaining, at a query execution module, a first query to interact with a database, comparing, by the query execution module, a first fingerprint associated with the first query to a set of multiple fingerprints stored in a fingerprint database, where the set of multiple fingerprints stored in the fingerprint database correspond to one or more respective queries that are associated with an execution restriction by the database based on a set of execution details stored with respective fingerprints of the set of multiple fingerprints, and controlling an execution of the first query based on whether the first fingerprint has a corresponding matching fingerprint to at least one of the set of multiple fingerprints stored in the fingerprint database.

An apparatus is described. The apparatus may include one or more memories storing processor executable code, and one or more processors coupled with the one or more memories. The one or more processors may individually or collectively be operable to execute the code to cause the apparatus to obtain, at a query execution module, a first query to interact with a database, compare, by the query execution module, a first fingerprint associated with the first query to a set of multiple fingerprints stored in a fingerprint database, where the set of multiple fingerprints stored in the fingerprint database correspond to one or more respective queries that are associated with an execution restriction by the database based on a set of execution details stored with respective fingerprints of the set of multiple fingerprints, and control an execution of the first query based on whether the first fingerprint has a corresponding matching fingerprint to at least one of the set of multiple fingerprints stored in the fingerprint database.

Another apparatus is described. The apparatus may include means for obtaining, at a query execution module, a first query to interact with a database, means for comparing, by the query execution module, a first fingerprint associated with the first query to a set of multiple fingerprints stored in a fingerprint database, where the set of multiple fingerprints stored in the fingerprint database correspond to one or more respective queries that are associated with an execution restriction by the database based on a set of execution details stored with respective fingerprints of the set of multiple fingerprints, and means for controlling an execution of the first query based on whether the first fingerprint has a corresponding matching fingerprint to at least one of the set of multiple fingerprints stored in the fingerprint database.

A non-transitory computer-readable medium storing code is described. The code may include instructions executable by one or more processors to obtain, at a query execution module, a first query to interact with a database, compare, by the query execution module, a first fingerprint associated with the first query to a set of multiple fingerprints stored in a fingerprint database, where the set of multiple fingerprints stored in the fingerprint database correspond to one or more respective queries that are associated with an execution restriction by the database based on a set of execution details stored with respective fingerprints of the set of multiple fingerprints, and control an execution of the first query based on whether the first fingerprint has a corresponding matching fingerprint to at least one of the set of multiple fingerprints stored in the fingerprint database.

In some examples of the method, apparatus, and non-transitory computer-readable medium described herein, controlling the execution of the first query may include operations, features, means, or instructions for killing the execution of the first query based on the first fingerprint having a matching fingerprint to at least one of the set of multiple fingerprints stored in the fingerprint database, where the corresponding matching fingerprint may be indicative of a blocked query.

In some examples of the method, apparatus, and non-transitory computer-readable medium described herein, controlling the execution of the first query may include operations, features, means, or instructions for running the first query based on the first fingerprint lacking a matching fingerprint to at least one of the set of multiple fingerprints stored in the fingerprint database.

Some examples of the method, apparatus, and non-transitory computer-readable medium described herein may further include operations, features, means, or instructions for adding the first fingerprint to the set of multiple fingerprints stored in the fingerprint database based on a first instance of a run time of the first query exceeding a threshold run time and releasing the first fingerprint from the set of multiple fingerprints stored in the fingerprint database based on an expiration of a timeout duration associated with the first fingerprint.

Some examples of the method, apparatus, and non-transitory computer-readable medium described herein may further include operations, features, means, or instructions for adding the first fingerprint to the set of multiple fingerprints stored in the fingerprint database based on one or more second instances of the run time of the first query exceeding the threshold run time and resetting the timeout duration for the first fingerprint based on one or more second instances of the run time of the first query exceeding the threshold run time.

In some examples of the method, apparatus, and non-transitory computer-readable medium described herein, controlling the execution of the first query may include operations, features, means, or instructions for running the first query based on the first query being associated with a hint that overrides a block of the first query.

In some examples of the method, apparatus, and non-transitory computer-readable medium described herein, controlling the execution of the first query may include operations, features, means, or instructions for running the first query based on the first query lacking a threshold quantity of statistical similarities to one or more second queries that may have corresponding matching fingerprints to at least one of the set of multiple fingerprints stored in the fingerprint database.

In some examples of the method, apparatus, and non-transitory computer-readable medium described herein, controlling the execution of the first query may include operations, features, means, or instructions for killing the execution of the first query based on the first query having a threshold quantity of statistical similarities to one or more second queries that may have corresponding matching fingerprints to at least one of the set of multiple fingerprints stored in the fingerprint database.

In some examples of the method, apparatus, and non-transitory computer-readable medium described herein, killing the execution of the first query may include operations, features, means, or instructions for killing the execution of the first query based on a database load associated with query execution of the database exceeding a load threshold.

In some examples of the method, apparatus, and non-transitory computer-readable medium described herein, the fingerprint database stores the set of multiple fingerprints and corresponding metadata associated with the set of multiple fingerprints.

In some examples of the method, apparatus, and non-transitory computer-readable medium described herein, the corresponding metadata associated with the set of multiple fingerprints includes a quantity of attempted executions for a respective query, time data for a duration of time taken to execute the respective query, a quantity of returned errors for the respective query, one or more indications of whether the respective query may be internally blocked, externally blocked, or both, a quantity of timeouts associated with the respective query, or any combination thereof.

In some examples of the method, apparatus, and non-transitory computer-readable medium described herein, killing the execution of the first query may include operations, features, means, or instructions for killing the execution of the first query and one or more subsequent queries based on one or more characteristics of duress being present for the database associated with the first query.

In some examples of the method, apparatus, and non-transitory computer-readable medium described herein, the first query includes a structured query language (SQL) query within code that sends the first query to the query execution module.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
obtaining, at a query execution module, a first query to interact with a database;
comparing, by the query execution module, a first fingerprint associated with the first query to a plurality of fingerprints stored in a fingerprint database, wherein the plurality of fingerprints stored in the fingerprint database correspond to one or more respective queries that are associated with an execution restriction by the database based at least in part on a set of execution details stored with respective fingerprints of the plurality of fingerprints; and
controlling an execution of the first query based at least in part on whether the first fingerprint has a corresponding matching fingerprint to at least one of the plurality of fingerprints stored in the fingerprint database.

2. The method of claim 1, wherein controlling the execution of the first query comprises:
killing the execution of the first query based at least in part on the first fingerprint having a matching fingerprint to at least one of the plurality of fingerprints stored in the fingerprint database, wherein the corresponding matching fingerprint is indicative of a blocked query.

3. The method of claim 1, wherein controlling the execution of the first query comprises:
running the first query based at least in part on the first fingerprint lacking a matching fingerprint to at least one of the plurality of fingerprints stored in the fingerprint database.

4. The method of claim 3, further comprising:
adding the first fingerprint to the plurality of fingerprints stored in the fingerprint database based at least in part on a first instance of a run time of the first query exceeding a threshold run time; and
releasing the first fingerprint from the plurality of fingerprints stored in the fingerprint database based at least in part on an expiration of a timeout duration associated with the first fingerprint.

5. The method of claim 4, further comprising:
adding the first fingerprint to the plurality of fingerprints stored in the fingerprint database based at least in part on one or more second instances of the run time of the first query exceeding the threshold run time; and
resetting the timeout duration for the first fingerprint based at least in part on one or more second instances of the run time of the first query exceeding the threshold run time.

6. The method of claim 1, wherein controlling the execution of the first query comprises:
running the first query based at least in part on the first query being associated with a hint that overrides a block of the first query.

7. The method of claim 1, wherein controlling the execution of the first query comprises:
running the first query based at least in part on the first query lacking a threshold quantity of statistical similarities to one or more second queries that have corresponding matching fingerprints to at least one of the plurality of fingerprints stored in the fingerprint database.

8. The method of claim 1, wherein controlling the execution of the first query comprises:
killing the execution of the first query based at least in part on the first query having a threshold quantity of statistical similarities to one or more second queries that have corresponding matching fingerprints to at least one of the plurality of fingerprints stored in the fingerprint database.

9. The method of claim 8, wherein killing the execution of the first query further comprises:
killing the execution of the first query based at least in part on a database load associated with query execution of the database exceeding a load threshold.

10. The method of claim 1, wherein the fingerprint database stores the plurality of fingerprints and corresponding metadata associated with the plurality of fingerprints.

11. The method of claim 10, wherein the corresponding metadata associated with the plurality of fingerprints comprises a quantity of attempted executions for a respective query, time data for a duration of time taken to execute the respective query, a quantity of returned errors for the respective query, one or more indications of whether the respective query is internally blocked, externally blocked, or both, a quantity of timeouts associated with the respective query, or any combination thereof.

12. The method of claim 1, wherein killing the execution of the first query further comprises:
killing the execution of the first query and one or more subsequent queries based at least in part on one or more characteristics of duress being present for the database associated with the first query.

13. The method of claim 1, wherein the first query comprises a structured query language (SQL) query within code that sends the first query to the query execution module.

14. An apparatus, comprising:
one or more memories storing processor-executable code; and
one or more processors coupled with the one or more memories and individually or collectively operable to execute the code to cause the apparatus to:
obtain, at a query execution module, a first query to interact with a database;
compare, by the query execution module, a first fingerprint associated with the first query to a plurality of fingerprints stored in a fingerprint database, wherein the plurality of fingerprints stored in the fingerprint database correspond to one or more respective queries that are associated with an execution restriction by the database based at least in part on a set of execution details stored with respective fingerprints of the plurality of fingerprints; and
control an execution of the first query based at least in part on whether the first fingerprint has a corresponding matching fingerprint to at least one of the plurality of fingerprints stored in the fingerprint database.

15. The apparatus of claim 14, wherein, to control the execution of the first query, the one or more processors are individually or collectively operable to execute the code to cause the apparatus to:
kill the execution of the first query based at least in part on the first fingerprint having a matching fingerprint to at least one of the plurality of fingerprints stored in the fingerprint database, wherein the corresponding matching fingerprint is indicative of a blocked query.

16. The apparatus of claim 14, wherein, to control the execution of the first query, the one or more processors are individually or collectively operable to execute the code to cause the apparatus to:
run the first query based at least in part on the first fingerprint lacking a matching fingerprint to at least one of the plurality of fingerprints stored in the fingerprint database.

17. The apparatus of claim 16, wherein the one or more processors are individually or collectively further operable to execute the code to cause the apparatus to:
add the first fingerprint to the plurality of fingerprints stored in the fingerprint database based at least in part on a first instance of a run time of the first query exceeding a threshold run time; and
release the first fingerprint from the plurality of fingerprints stored in the fingerprint database based at least in part on an expiration of a timeout duration associated with the first fingerprint.

18. The apparatus of claim 17, wherein the one or more processors are individually or collectively further operable to execute the code to cause the apparatus to:
add the first fingerprint to the plurality of fingerprints stored in the fingerprint database based at least in part on one or more second instances of the run time of the first query exceeding the threshold run time; and
reset the timeout duration for the first fingerprint based at least in part on one or more second instances of the run time of the first query exceeding the threshold run time.

19. The apparatus of claim 14, wherein, to control the execution of the first query, the one or more processors are individually or collectively operable to execute the code to cause the apparatus to:
run the first query based at least in part on the first query being associated with a hint that overrides a block of the first query.

20. A non-transitory computer-readable medium storing code, the code comprising instructions executable by one or more processors to:
obtain, at a query execution module, a first query to interact with a database;
compare, by the query execution module, a first fingerprint associated with the first query to a plurality of fingerprints stored in a fingerprint database, wherein the plurality of fingerprints stored in the fingerprint database correspond to one or more respective queries that are associated with an execution restriction by the database based at least in part on a set of execution details stored with respective fingerprints of the plurality of fingerprints; and
control an execution of the first query based at least in part on whether the first fingerprint has a corresponding matching fingerprint to at least one of the plurality of fingerprints stored in the fingerprint database.
